(19) United States
(12) Patent Application Publication
(10) Pub. No.: US 2016/0028693 A1
(43) Pub. Date: Jan. 28, 2016

(54) APPARATUS AND METHOD FOR SECURITY OF INDUSTRIAL CONTROL NETWORKS

(71) Applicant: GE Intelligent Platforms, Inc., Charlottesville, VA (US)

(72) Inventor: Kenneth Wayne CRAWFORD, Charlottesville, VA (US)

(21) Appl. No.: 14/663,003

(22) Filed: Mar. 19, 2015

Related U.S. Application Data
(60) Provisional application No. 62/029,695, filed on Jul. 28, 2014.

(51) Int. Cl. H04L 29/06; H04L 29/12

(52) U.S. Cl. CPC H04L 63/0281; H04L 61/6022; H04L 61/2007; H04L 63/14; H04L 63/105

(57) ABSTRACT

Approaches for providing security for a programmable logic controller (PLC) are provided and include cloning a security module as a PLC proxy by copying at least one of a media access control (MAC) address and an internet protocol (IP) address of the PLC and determining, based on a predetermined security criteria, whether to route the message to the PLC. Based on the determination, the message is selectively routed to the PLC. So configured, by cloning the security module as the PLC proxy is effective to route network traffic intended for the PLC to the security module.

### CROSS REFERENCE TO RELATED APPLICATIONS

This application claims the benefit under 35 U.S.C. §119 (e) to U.S. Provisional Application No. 62/029695 entitled APPARATUS AND METHOD FOR SECURITY OF INDUSTRIAL CONTROL NETWORKS, filed Jul. 28, 2014, the content of which is incorporated herein by reference in its entirety.

### BACKGROUND OF THE INVENTION

1. Field of the Invention

The subject matter disclosed herein generally relates to network security and, more specifically, to providing security for industrial control systems.

2. Brief Description of the Related Art

Various systems deploy sensors that are used to obtain different types of information. These systems also sometimes include actuators that operate particular devices within these systems. The sensors are often deployed in industrial control systems.

Computer viruses and other security threats exist in today's networking environment. These threats also threaten industrial control systems. If no action were to be taken to combat these security threats, the industrial control systems (and their associated devices) could potentially be harmed or improperly operated by unauthorized users to mention two adverse consequences.

Various security approaches have been utilized to secure industrial control systems. For instance, software patches have been used in an attempt to alleviate security problems. However, these patches have problems. For example, the use of a patch might require shutting the entire control network down in order to install the patch. Additionally, the patches are typically ineffective in combating most security threats, because the patches are not compatible with the existing control system software code or are simply incapable of stopping the security threat. Traditionally there is a large time between the time that the security tag has been identified and the patch being installed. All the while, the control system is vulnerable to this new threat.

All of these problems have resulted in general user dissatisfaction with previous approaches. Due to the high frequency of new patch releases and the impact to daily operations result in perceived low system quality.

### BRIEF DESCRIPTION OF THE INVENTION

The approaches described herein provide a network security module that acts as a computing engine and as a sentinel. In one aspect, the network security module is installed between the programmable logic controller (PLC) and the control network. The network security module acts as a proxy or impersonator. In these regards, the network security module is transparent to users on the control network and cloud network. In other words, users on the cloud believe they have direct access to the control network (and devices coupled to the control network), when in fact all the traffic goes through and is controlled by the network security module. In this way, the PLC and the control network are protected from security threats. Additionally, this module will also protect the control network against threats which came through a local network on a local server.

In some approaches, security for a programmable logic controller (PLC) is provided and includes cloning a security module as a PLC proxy by copying at least one of a media access control (MAC) address and an internet protocol (IP) address of the PLC and determining, based on a predetermined security criteria, whether to route the message to the PLC. Based on the determination, the message is selectively routed to the PLC. So configured, by cloning the security module as the PLC proxy is effective to route network traffic intended for the PLC to the security module.

In some approaches, monitoring and filtering the network traffic may occur before transmitting the message to the PLC. The security module may also be updated with a new security criteria. This update may occur automatically or upon prompting by a user and/or computing device. The update may further occur via wirelessly communicating with a remote networking system (e.g., a “cloud” network) to apply the new security criteria thereto. In some approaches, an indication of a presence of a security threat is transmitted to a user.

In many examples, an approach for providing security to the PLC includes coupling a network security module to the PLC, a remote network, and a control network. At least one network address associated with the identity of the PLC is received, and the security module is configured with the at least one network address. Data addressed to the PLC is received at the network security module, and the data is routed to the PLC upon verifying the safety of the data.

In some approaches, the received network address includes at least one of a media access control address and an internet protocol address of the PLC. In many of these forms, the data is received from the remote network and/or the control network prior to arriving at the PLC. In other words, the network security module may “intercept” messages intended to the PLC as a way to ensure the safety of the PLC. Upon verifying the safety of the data, the network security module may route the data to the PLC, the remote network, and/or the control network.

In yet other examples, a system for providing security for a programmable logic control (PLC) is provided and includes a network security module being operatively coupled to a remote networking system, a control network, and the PLC. The network security module is configured to clone a PLC proxy for the PLC module such that the network security model copies at least one of a media access control (MAC) address and an internet protocol (IP) address of the PLC. The network security module is further configured to determine, based on a predetermined security criteria, whether to route network traffic from at least one of the remote networking system and the control network to the PLC and selectively route the network traffic to the PLC based on the determination. In some approaches, the network security module may block incoming data from the remote networking system and/or the control network.

### BRIEF DESCRIPTION OF THE DRAWINGS

For a more complete understanding of the disclosure, reference should be made to the following detailed description and accompanying drawings wherein:

FIG. 1 comprises a block diagram of a system including a control network that includes a network security module according to various embodiments of the present invention;

FIG. 2 comprises a flow chart showing the operation of a network security module according to various embodiments of the present invention;

FIG. 3 comprises a flow chart showing aspects of the operation of a network control module according to various embodiments of the present invention;

FIG. 4 comprises a flow chart showing other aspects of the operation of a network control module according to various embodiments of the present invention;

FIG. 5 comprises a flow chart showing yet other aspects of the operation of a network control module according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

The approaches described herein provide a network security module, which acts as a target imposter to execute and/or implement network patches (or other security hardware and/or software) by acting as a PLC proxy. In other words, the network security module implements the functionality of security patches (or other security hardware and/or software). These approaches eliminate the need to update PLC software to implement PLC network security patches by enabling an external device to provide network protection against known security threats that would otherwise need to be provided by the PLC by software patch updates installed thereon. The security module stays current by obtaining automatic updates from the cloud resulting in minimal PLC downtime and minimal latency from initial threat detection to protection. The security module can implement security patches that would otherwise be impossible to implement in the current PLC architecture. The security module also provides threat notifications to inform the client/user of network threats, network configuration changes, attacks and unusual network activity.

Once installed and in one aspect, the network security module clones (or copies) the media access control (MAC) and internet protocol (IP) addresses of the PLC to become a PLC proxy. In some other aspects, the network security module monitors all network traffic and filters traffic that is identified as a network security threat thereby preventing that traffic reaching the PLC and thus preventing a cyber-attack on the asset. In another aspect, an independent third generation (3G) or wireless connection to the cloud provides a path for continual sentinel software updates to keep the functionality of the security module up to date as well as providing threat messaging back to the user.

The present approaches provide various advantages and benefits. For example, the present approaches provide industrial systems with up-to-date methods of cyber security protection. The present approaches additionally do not require trained source personnel to implement, install and validate operation of patches. Consequently, system operating costs are reduced. The present approaches also add cyber security/network security without redesigning/modernizing network infrastructure.

Other advantages provided include the automatic update of security software and no downtime for the PLC to update software. There is also no need to invest heavily in new network infrastructure. The software used to implement these approaches can be very quickly installed.

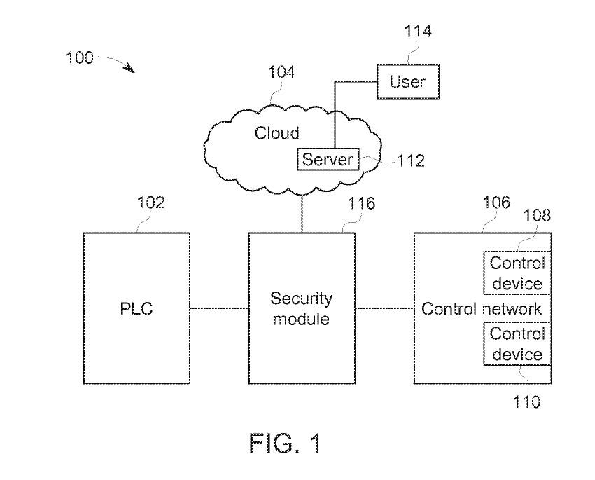

Referring now to FIG. 1, one example of a system 100 for providing security to industrial networks is described. The system 100 includes a programmed logic controller (PLC) 102, a cloud network 104, and a control network 106. The control network 106 includes control devices 108 and 110. The cloud network 104 includes a server 112 and the server 112 is coupled to a user 114. The PLC 102, cloud network 104, and control network 106 are coupled to a network security module 116.

The PLC 102 is any processing device that executes programmed computer instructions. The cloud network 104 is any type of network or combination of networks. The server 112 provides, for example, routing functions for data moving to and from the control network 106.

The control network 106 includes control devices 108 and 110. The control devices 108 and 110 may be configured to provide any type of control functionality. For example, the control devices 108 and 110 may operate switches, actuate valves, or activate/deactivate devices. The control devices 108 and 110 may be coupled together in a control network 106 with any network topology or using any type of network or combination of networks. The control network 106 may be disposed in any type of environment, setting, or location such as a factory, industrial plant, school, business, home, to mention a few examples. Other examples are possible.

The security module 116 clones (or copies) the media access control (MAC) and internet protocol (IP) addresses of the PLC to become a PLC proxy. In some other aspects, the security module 116 monitors all network traffic it receives from the cloud network 104 and filters traffic that is identified as a network security threat thereby preventing that traffic by reaching the PLC 102 thereby preventing a cyber-attack on the asset. Along with this, the threat can also come from control network 106 (for example, someone can use an infected USB thumbdrive on a maintenance laptop that is connected to the controls network).

In one example of the operation of the system of FIG. 1, the network security module 116 acts as a proxy or impersonator. In these regards, the network security module 116 is transparent to the user 114 on the cloud network 104. In other words, users on the cloud network 104 believe they have direct access to the control network 106, when in fact all the traffic goes through the network security module 116. Additionally, if the threat originates within control network 106 then the threat will be mitigated by 116 and 116 will forward a time stamped message to the server 104 via network. In this way, the PLC 102 and the control network 106 are protected from security threats external to the control network 106 and internal threats as well. For example, cyber attacks originating from the cloud network 104 will not reach the control network 106. Additionally, cyber-attacks originating from control network 106 will not reach cloud network 104. In some aspects, a PLC program (originally downloaded) can be obtained from its PLC and uploaded to the cloud to validate equality (i.e., the program in the PLC was the same program that was downloaded) ensuring that the original program has not been altered.

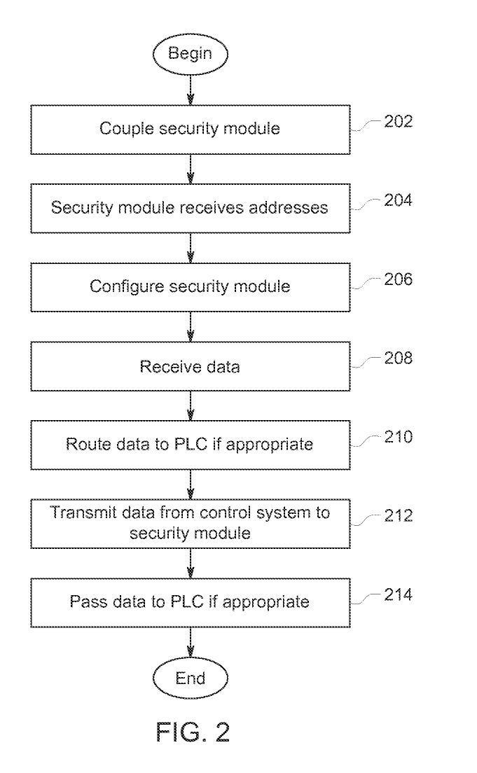

Referring now to FIG. 2, one example of how a security module (e.g., the security module 116 of FIG. 1) operates is described.

At step 202, a network security module is coupled to the PLC, the cloud network, and the control network. The coupling can be manually accomplished by a technician.

At step 204, the security module receives network addresses associated with the identity of the PLC. For example, it receives the MAC and IP addresses of the PLC. At step 206, the security module is configured with the address information (e.g., the MAC and IP addresses it has received). Also at step 206, the cloning of MAC and IP addresses is configured.

Consequently, at step 208 data sent from the cloud and addressed to the PLC goes first to the security module and is then routed to the PLC at step 210 if appropriate. From the PLC, the data may be sent to the control network. The data might also be transmitted to the cloud. For example, data that is deemed not to be a security threat may be passed to the PLC and control network. The data coming from the control network is being screened by the network security device, and if a threat is detected then a time stamped threat message is sent to the cloud.

At step 212, data from the control system is transmitted to the security module. At step 214, the data is passed to the PLC if appropriate. The data can then be passed to the cloud.

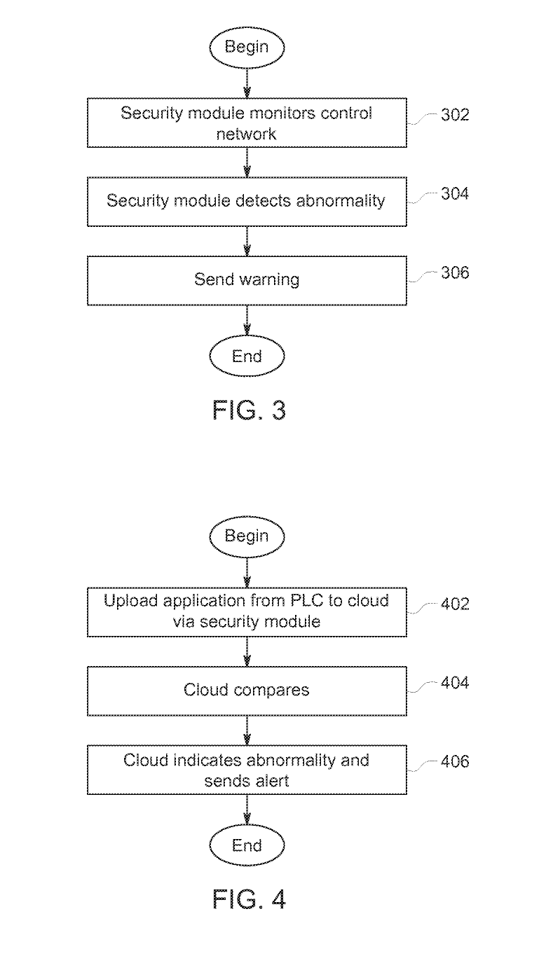

Referring now to FIG. 3, one example of how the security module provides security is described. At step 302, the security module monitors data traffic at the control network. For example, the security module may monitor data traffic on the control network for certain addresses, users, or other types of information (including data content) in the data.

At step 304, the security module detects an abnormality during its monitoring of traffic on the control network. In one example, the abnormality is a new address detected in the data that is being transmitted. In another example, the abnormality is a change in bandwidth of the traffic on the control network. Other examples of abnormalities are possible.

At step 306, once an abnormality is determined or detected, the security module sends a warning or alert message to an appropriate entity. For example, the message may be sent to a central control center coupled to the cloud. In another example, the appropriate authorities may be altered. The message may be in any format such as an email or voice message to mention two examples.

Referring now to FIG. 4, another example showing how the security module operates as described. At step 402, an application is uploaded from the PLC to the cloud via the security module. By “application”, it is meant any software application including the code, data, or other information comprising the application.

At step 404, the cloud makes a comparison between the application and reference information. In these regards, the cloud may have reference data that shows how an application is to be normally configured.

At step 406, if the comparison indicates an abnormality, then an alert message is sent to the user. For example, the message may be sent to a central control center coupled to the cloud. In another example, the appropriate authorities may be altered. The message may be in any format such as an email or voice message to mention two examples.

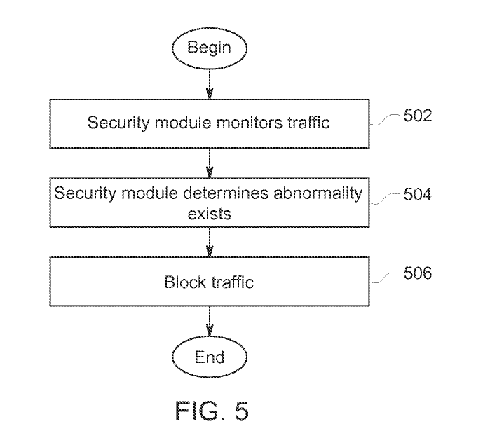

Referring now to FIG. 5, another example showing other aspects of security module operation is described. At step 502, the security module monitors incoming traffic from the cloud (or the control network). For example, the security module may monitor for certain addresses.

At step 504, it determines if any abnormality exists. For example, the security module may determine that the traffic is from the wrong user (e.g., an unauthorized user or a user associated with an unauthorized web site to mention two examples). In these regards, the network security module may have stored a list of inappropriate users or web sites to determine the nature of the user.

At step 506, if there is an abnormality, the security module blocks the incoming traffic. Consequently, data traffic that could potentially harm the control network (and devices disposed within the control network) is prevented from reaching the control network and is stopped at the network security module.

In addition and as mentioned, a threat may also originate from a control network to PLC. For example, the data coming from the control network may be screened by the network security module as described, and if a threat is detected then a time stamped threat message (or other type of alert) may be sent to the cloud.

It will be appreciated by those skilled in the art that modifications to the foregoing embodiments may be made in various aspects. Other variations clearly would also work, and are within the scope and spirit of the invention. It is deemed that the spirit and scope of that invention encompasses such modifications and alterations to the embodiments herein as would be apparent to one of ordinary skill in the art and familiar with the teachings of the present application.

What is claimed is:

1. A method for providing security for a programmable logic controller (PLC), comprising:
cloning a security module as a PLC proxy for a PLC module, the cloning comprising copying at least one of a media access control (MAC) address and an internet protocol (IP) address of the PLC;
determining, based on a predetermined security criteria, whether to route a message to the PLC; and
selectively routing the message to the PLC based upon the determination;
wherein the step of cloning the security module as the PLC proxy is effective to route network traffic intended for the PLC to the security module.

2. The method of claim 1, further comprising the step of monitoring and filtering the network traffic before transmitting the message to the PLC.

3. The method of claim 1, further comprising the step of updating the security module with a new security criteria.

4. The method of claim 3, wherein the step of updating the security module comprises wirelessly communicating with a remote networking system to download the new security criteria.

5. The method of claim 1, further comprising the step of transmitting an indication of a presence of a security threat to a user.

6. A method for providing security for a programmable logic control (PLC), comprising:
coupling a network security module to the PLC, a remote network, and a control network;
receiving at least one network address associated with the identity of the PLC;
configuring the security module with the at least one network address;
receiving data addressed to the PLC at the network security module; and
routing the data to the PLC upon verifying safety of the data.

7. The method of claim 6, wherein the step of receiving the at least one network address comprises receiving at least one of a media access control (MAC) address and an internet protocol (IP) address of the PLC.

8. The method of claim 6, wherein the step of receiving data comprises receiving data from the remote network addressed to the PLC before arriving at the PLC.

9. The method of claim 6, wherein the step of receiving data comprises receiving data from the control network addressed to the PLC before arriving at the PLC.

10. The method of claim 6, further comprising the step of routing data to at least one of the PLC, the remote network, and the control network.

11. The method of claim 6, further comprising the step of transmitting data from the network security module to at least one of the remote network and the control network.

12. A system for providing security for a programmable logic control (PLC), comprising:
a network security module being operatively coupled to a remote networking system, a control network, and the PLC, wherein the network security module is configured to clone a PLC proxy for the PLC module such that the network security model copies at least one of a media access control (MAC) address and an internet protocol (IP) address of the PLC, the network security module being configured to determine, based on a predetermined security criteria, whether to route network traffic from at least one of the remote networking system and the control network to the PLC and selectively route the network traffic to the PLC based on the determination.

13. The system of claim 12, wherein the network security module is configured to monitor and filter the network traffic prior to transmitting the network traffic to the PLC.

14. The system of claim 12, wherein the predetermine security criteria is automatically updated.

15. The system of claim 12, wherein the network security module is configured to transmit an indication of a presence of a security threat to a user.

16. The system of claim 12, wherein the network security module is further configured to block incoming data from at least one of the remote networking system and the control network.
